(19) United States
(12) Patent Application Publication
(10) Pub. No.: US 2017/0048014 A1
(43) Pub. Date: Feb. 16, 2017

(54) APPARATUS AND METHOD FOR GENERATING SCRAMBLING CODES FOR REPETITION TRANSMISSIONS

(71) Applicant: Spreadtrum Hong Kong Limited, Shanghai (CN)

(72) Inventors: Karl Marko Juhani LAMPINEN, Oulu (FI); Arto Johannes LEHTI, Oulu (FI)

(73) Assignee: SPREADTRUM HONG KONG LIMITED, Shanghai (CN)

(21) Appl. No.: 14/825,748

(22) Filed: Aug. 13, 2015

(51) Int. Cl. H04J 13/10; H04W 72/04

(52) U.S. Cl. CPC H04J 13/10; H04W 72/0466; H04W 72/042

(57) ABSTRACT

The present application describes solutions to initialize an initial state of a scrambling sequence generator in a wireless network requiring a number of repetitive transmission of control and/or data, signals, in order to maximize radio coverage and reduce interference. Methods and apparatus are provided for efficient scrambling code generation in a wireless network. In one embodiment, methods and apparatus include identifying a cycle of a plurality of radio frames based on a common frame index, initializing scrambling code generation at start of a subframe in the identified cycle of the plurality of radio frames based on at least the common frame index, and generating a scrambling code. When initiating a scrambling code generation, the initialization starts at a radio frame by counting a system frame number.

### BACKGROUND

I. Technical Field

The present disclosure relates to communications in wireless networks and, in particular, to methods and apparatus for providing scrambling codes for use in wireless networks.

II. Background

As wireless networks have evolved from the Global System for Mobile Communications/General Packet Radio Service (GSM/GPRS) system to the current Long Term Evolution (LTE) system, the communication standards have been enhanced to provide wider coverage at higher data speeds. One technical challenge for such networks is to support high complexity devices as well as low complexity devices. Another challenge is to reduce cost of overall network maintenance by minimising the number of concurrent radio access technologies (RATs) as evolved network deployments, such as LTE, are added.

Machine-Type Communications (MTC) protocols are currently being developed to support low cost and low complexity devices, such as vending machines, water and gas meters, etc. It is envisaged that MTC User Equipment (UEs) will be deployed in large numbers, large enough to support their own eco-system. MTC UEs used for many applications will require low operational power consumption and are expected to communicate with infrequent small burst transmissions. Many MTC UEs have thus been targeted for low-end (low average revenue per user, low data rate) applications.

Even though GSM/GPRS can provide low-cost devices with good coverage, there is increasing need to also support MTC in the LTE radio interface. The continued reliance on GSM/GPRS is inefficient in that it requires network operators to support multiple RATs. Moreover, other protocols, such as LTE, make more efficient use of spectrum than GSM/GPRS.

There is also a substantial market for Machine-2-Machine (M2M) devices deployed deep inside buildings which would require coverage enhancement in comparison to the defined LTE cell coverage footprint. For example, some MTC UEs are installed in the basements of residential buildings or locations shielded by foil-hacked insulation, metalized windows or traditional thick-walled building construction, and these UEs would experience significantly greater penetration losses on the radio interface than normal LTE devices. The MTC UEs in the extreme coverage scenario might have characteristics such as very low data rate, greater delay tolerance, and no mobility, and therefore some messages/channels may not be required. Therefore, it would be beneficial to find a solution to support low-end MTC UEs in LTE system.

The 3^{rd} Generation Partnership Project (3GPP) has studied to find a solution. It was concluded in 3GPPTR 36.888 that a coverage improvement target of 15-20 dB for both Frequency Division Duplexing (FDD) and Time Division Duplexing (TDD) in comparison to normal LTE footprint could be achieved to support use cases in which MTC devices are deployed in challenging locations, e.g., deep inside buildings, and to compensate for gain loss caused by complexity reduction techniques. It was also concluded that,in order to increase coverage in the LTE system, data, or control subframes from such devices may need to be repeated multiple times, e.g., between 42 and 400 times. This presents a problem in that the LTE scrambling code repeats in every radio frame, such that it may be the same over several subframes of a repetition period. Consequently, interference may not necessarily average out over the several repetitions, which reduces coverage significantly.

The following symbols and abbreviations are referenced in the disclosure that follows:

| | |
|---|---|
| cᵢₙᵢₜ | initial state of the scrambling code generator |
| c_{k, i} | scrambling code of cell k repetition i |
| hₖ | channel coefficient of cell k |
| N | number of repetitions |
| N_{alloc} | slot allocation index |
| N_{ID}^{cell} | physical layer cell identity |
| n_{ID}^{DMRS, i} | DMRS scrambling identity |
| N_{fr} | frame number in cycle |
| N_{fr, max} | maximum frame number in cycle |
| N_{ID}^{MBSFN} | MBSFN area identity |
| n_{RNTI} | radio network temporary identifier |
| n_{RNTI, max} | maximum value of RNTI |
| nₛ | slot number within a radio frame |
| n_{SCID} | scrambling identity field |
| n | Gaussian noise |
| Pₙ | noise power |
| q | codeword index |
| SNR_{\hat{x}} | signal to noise ratio of \hat{x}ₖ |
| X | User specific SFN offset |
| xₖ | data symbols of cell k |
| \hat{x}ₖ | estimate of xₖ |
| Ω | scrambling code correlation |

One method to increase randomness is to change of redundancy version (RV) In repeated transmissions, which increases the effective code rate of the combined transmissions. Use of different redundancy versions for repeated subframes was proposed in 3GPP RP-150492. However, currently there are only 4 different RVs available. Hence, the randomization effect may be limited in the case of a large number of repetitions. Furthermore, interfering transmissions may use the same cycling of RVs.

The repeated subframes may be given different scrambling codes. However, in current LTE system a scrambling sequence for Demodulation Reference Signal (DM-RS) and Physical Downlink Shared CHannel (PDSCH) data is initialized at the beginning of each subframe. The initialization code depends on slot number of the radio frame and hence it spans only one radio frame. If repetitions span multiple radio frames, the same scrambling sequence is reused.

The Wide Code Division Multiple Access (WCDMA) system provides a scrambling code generation and scrambling sequence having a length of 38,400 samples which equal to a radio frame of 10 ms. While 3GPPTS 25.213 describes that a scrambling sequence generator is initialized with a known initial state in every radio frame as described in section 5.2.2. 3GPPTS 25.211 also discloses in sections 7.1 and 7.8 that five data subframes in High Speed Packet Access (HSPA) system fit into one radio frame in the time domain. This indicates that a scrambling code is repeated every sixth HSPA data subframe and is not suitable for large number of repetitions without modifications to the LTE system.

With regard to Wireless Local Area Network (WLAN) system, IEEE Std 802.11™-2012 discloses that each Physical Layer Convergence Protocol (PLCP) packet is scrambled by a pseudorandom sequence where an initial state of a scrambler is set to a pseudorandom nonzero state. This initial state is included into the transmitted data from which a receiver acquires the information. This method could guarantee that all repeated transmissions would have unique scrambling sequence with high probability. However, the LTE system does not have any means to indicate the initial state in physical layer signaling. Hence, the method from the WLAN system is not applicable to the LTE system.

As another existing scrambling solution. 3GPPTR 45.820 discloses in section 7.1.2 and FIG. 7.1.2-7 that a Downlink Control Information (DCI) interval may contain a DCI burst which may be repeated in extended coverage case. The whole transmission burst is scrambled by a single sequence and a scrambling sequence generator is initialized in the beginning of the burst based on a frame number. Further, a DCI burst length is multiple of slots which means that multiple DO repetitions may fit into a single frame. The burst may contain repeated data, but no separate initialization of the code is made.

With respect the LTE system, 3GPPTS 36.211 discloses that a scrambling sequence generator is initialized at start of each subframe, where a value of an initial state cᵢₙᵢₜ depends on a transport channel type according to the following Equation 1:

$${c}_{init} = \{ \begin{matrix}{n}_{RNTI} \cdot {2}^{14} + q \cdot {2}^{13} + ⌊ {n}_{s} / 2 ⌋ \cdot {2}^{9} + {N}_{ID}^{cell} & for PDSCH \\ ⌊ {n}_{s} / 2 ⌋ \cdot {2}^{9} + {N}_{ID}^{MBSFN} & for PMCH\end{matrix} \qquad ( Equation 1 )$$

Where n_{RNTI} corresponds to the Radio Network Temporary Identifier (RNTI) associated with the PDSCH transmission as described in section 7.1 of 3GPPTS 36.213.

The current specification support following ranges:
q∈{0,1} equals the codeword index
nₛ equals slot number within a radio frame (Nₛ∈[0,19])
N_{ID}^{cell}∈[0.503] and n_{Id}⁽ⁿ^{_{SCID}}⁾∈[0,503]
n_{RNTI} is 16 bit wide
n_{SCID}∈{0,1}

3GPPTS 36.211 discloses that an initialization of a scrambling code generator for PDSCH and DM-RS, and a pseudo-random sequence generator is initialized with the following equation at the start of each subframe:

cᵢₙᵢₜ=(└nₛ/2┘+1)·(2n_{ID}⁽ⁿ^{_{SCID}}⁾+1)2¹⁶+n_{SCID} (Equation 2).

The quantities n_{ID}⁽ⁱ⁾, i=0,1, are given by:
n_{ID}⁽ⁱ⁾=N_{ID}^{cell} if no value for n_{ID}^{DMRS,i} is provided by higher layers or if DCI format 1A, 2B or 2C is used for the DCI associated with the PDSCH transmission;
n_{ID}⁽ⁱ⁾=n_{ID}^{DMRS,i} otherwise.

The value of n_{SCID} is zero unless specified otherwise. For a PDSCH transmission on ports 7 or 8, n_{SCID} given by a DCI format 2B, 2C or 2D associated with the PDSCH transmission. In case of DCI format 2B, n_{SCID} is indicated by the scrambling identity field according to Table 6.10.3.1-1. In case of DCI format 2C or 2D, n_{SCID} is given by Table 5.3.3.1.5C-1 in 3GPPTS 36.212.

However, the current technology of initializing scrambling code generation as disclosed in 3GPPTS 36.211 does not provide long enough scrambling if data is repeated multiple times, leading to potential loss of interference averaging gain in receiver combining. Therefore, the present disclosure proposes to initialize an initial state of a scrambling sequence generator in such a way that a different scrambling sequence is produced for each of the repeated subframe.

Currently, 3GPPTR 36.824 discloses repeating subframes four times for uplink Transmission Time Interval (TTI) bundling. As the number of repetitions is less than a scrambling code sequence duration which is one radio frame (i.e., 10 subframes), the short scrambling code does not present a problem.

For example, considering a serving cell and one or more interfering cells transmitting repeated subframe data x₁ and x₂ with scrambling code c_{1,i} and c_{2,i}, where i equals a repetition index. Let us also assume channel coefficients h₁ and h₂ and Gaussian noise n. The received and channel compensated signal at a UE, over N subframes, is then:

\hat{x}₁=Σᵢ^{N}h*₁c*_{1,i}(h₁c_{1,i}x₁+h₂c_{2,i}x₂+n).

Now assuming that c*_{1,i}c_{1,i}=1, E[x*₁x₁]=1, E[x*₂x₂]=1 and c*_{1,i}c_{2,k}=xᵢₖ, the Signal to Noise Ratio (SNR) equals:

$${SNR}_{\hat{x}} = \frac{E [ {\vert {\sum }_{i}^{N} {h}_{1}^{*} {c}_{1 , i}^{*} {h}_{1} {c}_{1 , i} {x}_{1} \vert}^{2} ]}{E [ {\vert {\sum }_{i}^{N} {h}_{1}^{*} {c}_{1 , i}^{*} {h}_{2} {c}_{2 , i} {x}_{2} + n \vert}^{2} ]} = \frac{{( N \vert {h}_{1}^{*} {h}_{1} \vert )}^{2}}{{\vert {h}_{1}^{*} {h}_{2} \vert}^{2} {\vert {\sum }_{i}^{N} {c}_{1 , i}^{*} {c}_{2 , i} \vert}^{2} + {P}_{n}} . \qquad ( Equation 3 )$$

For simplicity, one could assume that random variable E[|xᵢₖ|²]=Ω and E[xᵢᵢx*ₖₖ]=0. In an extreme case where a scrambling code does not change between subframes, cross correlation is constant over the N combined subframes and the SNR is:

$${SNR}_{\hat{x}} = \frac{{( N \vert {h}_{1}^{*} {h}_{1} \vert )}^{2}}{{\vert {h}_{1}^{*} {h}_{2} \vert}^{2} {N}^{2} {\vert {x}_{n} \vert}^{2} + {P}_{n}} = \frac{{( N \vert {h}_{1}^{*} {h}_{1} \vert )}^{2}}{{\vert {h}_{1}^{*} {h}_{2} \vert}^{2} {N}^{2} Ω + {P}_{n}} . \qquad ( Equation 4 )$$

In another extreme case, cross correlation changes for every subframe, In this case, the SNR is:

$${SNR}_{\hat{x}} = \frac{{( N \vert {h}_{1}^{*} {h}_{1} \vert )}^{2}}{{\vert {h}_{1}^{*} {h}_{2} \vert}^{2} ( {\sum }_{i}^{N} {\vert {x}_{ii} \vert}^{2} + {\sum }_{iik}^{N} {x}_{ii} {x}_{kk}^{*} ) + {P}_{ii}} = \frac{{( N \vert {h}_{1}^{*} {h}_{1} \vert )}^{2}}{{\vert {h}_{1}^{*} {h}_{2} \vert}^{2} N Ω + {P}_{n}} . \qquad ( Equation 5 )$$

As can be seen by comparing equations (4) and (5), SNR gain is achieved if scrambling code is always different because interference component is multiplied by N² Ω and NΩ, respectively.

Embodiments of the present application would thus be beneficial for an apparatus requiring a number of repetitive transmission of control and/or data signals, e.g., an LTE UE or system, to have a known initial state for every repetition, where every repetition has different scrambling code, and to have methods to indicate when to initialize an initial state in a physical layer signaling, in order to maximize radio coverage and reduce interference.

Consistent with embodiments of this disclosure, there is provided a method of providing efficient scrambling code generation in a wireless network. The method Includes generating a scrambling code. The method also includes identifying a cycle of a plurality of radio frames based on a common frame index. The method further includes Initializing the scrambling code at start of a subframe in the identified cycle of the plurality of radio frames based on the common frame index, When initiating a scrambling code generator, the initialization starts at a subframe by counting a system frame number.

Consistent with embodiments of this disclosure, there is provided a method of providing efficient scrambling code generation in a wireless network. The method includes generating a scrambling code. The method also includes identifying a cycle of a plurality of subframes based on a slot allocation index. The method further includes initializing the scrambling code at start of a subframe in the identified cycle of the plurality of subframes based on the slot allocation index. The scrambling code is initialized at start of a subframe in the identified cycle of the plurality of subframes for at least one of Physical Downlink Shared CHannel (PDSCH) and Demodulation Reference Signal (DM-RS).

Consistent with embodiments of this disclosure, there is provided an apparatus of providing efficient scrambling code generation in a wireless network. The apparatus comprises a computer readable storage medium storing programming for execution by a processor, and at least one processor. The processor is configured to include generating a scrambling code. The processor is also configured to include identifying a cycle of a plurality of radio frames based on a common frame index, The processor is further configured to include initializing the scrambling code at start of a radio frame in the identified cycle of the plurality of radio frames based on the common frame index. When initiating a scrambling code generator, the processor is configured to start the initialization of the scrambling code generator at a radio frame by counting a system frame number.

Consistent with embodiments of this disclosure, there is provided an apparatus of providing efficient scrambling code generation in a wireless network. The apparatus comprises a computer readable storage medium storing programming for execution by a processor, and at least one processor. The processor is configured to include generating a scrambling code. The processor Is also configured to Include identifying a cycle of a plurality of subframes based on a slot allocation index. The processor is further configured to include initializing the scrambling code at start of a subframe in the identified cycle of the plurality of subframes based on the slot allocation index. When initiating the scrambling code, the processor is configured to start the initialization of the scrambling code at a subframe in the identified cycle of the plurality of subframes for at least one of Physical Downlink Shared CHannel (PDSCH) and Demodulation Reference Signal (DM-RS).

Consistent with other disclosed embodiments, non-transitory computer-readable storage media may store program instructions, which may be executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 shows an exemplary system architecture of a wireless network according to an embodiment of the present disclosure;

FIG. 2 illustrates an exemplary system for providing uplink and downlink services according to an embodiment of the present disclosure;

FIG. 3 illustrates an exemplary system for providing uplink and downlink services and its control and data channels according to an embodiment of the present disclosure;

FIG. 4 illustrates an exemplary sequence generator process according to an embodiment of the present disclosure;

FIG. 5 illustrates an exemplary frame structure according to an embodiment of the present disclosure;

FIG. 6 illustrates an exemplary frame structure for initiating a scrambling code generator based on a common cycle, according to an embodiment of the present disclosure;

FIG. 7 illustrates an exemplary method for initiating a scrambling code generator based on a common cycle, according to an embodiment of the present disclosure;

FIG. 8 illustrates a subframe structure for initiating a scrambling code generator based on scrambling code pattern timing, according to an embodiment of the present disclosure;

FIG. 9 illustrates another exemplary method for initiating a scrambling code generator based on scrambling code pattern timing, according to an embodiment of the present disclosure;

FIG. 10A illustrates an exemplary scrambling code generator according to an embodiment of the present disclosure;

FIG. 10B illustrates an exemplary scrambling code generator with transforming a radio network temporary identifier according to an embodiment of the present disclosure;

FIG. 11A illustrates a first exemplary initial state setting according to an embodiment of the present disclosure;

FIG. 11B illustrates a second exemplary initial state setting according to an embodiment of the present disclosure;

FIG. 11C illustrates a third exemplary initial state setting according to an embodiment of the present disclosure; and

FIG. 12 illustrates an exemplary block diagram of a system apparatus or a UE apparatus.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The present disclosure provides systems, apparatus, and methods for providing scrambling codes for repeated transmissions in wireless networks. The proposed methods for providing scrambling code are described with respect to LTE systems and/or LTE UE. However, one of ordinary skill will recognize that the proposed methods are applicable to other networks, systems and/or devices in which there are a number of repetitive transmissions.

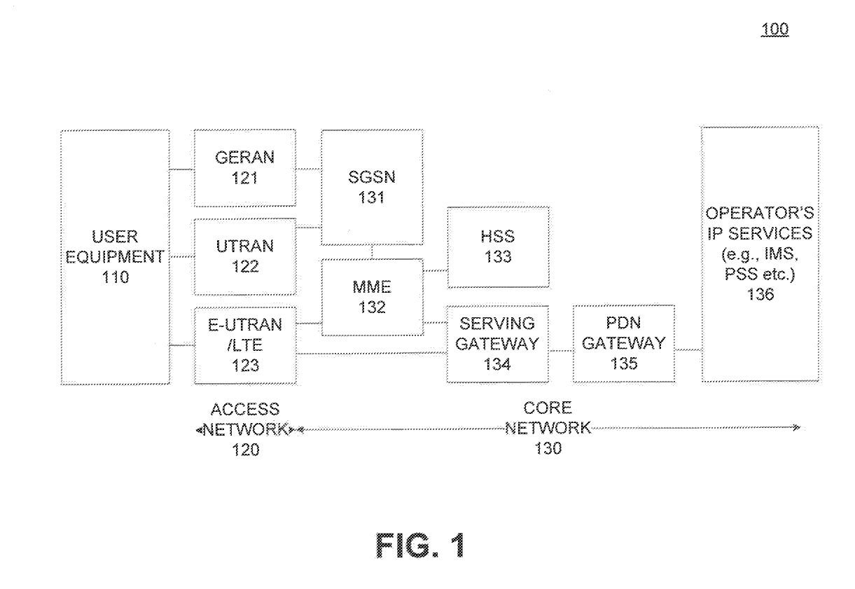

FIG. 1 shows an exemplary system architecture of a wireless network according to an embodiment of the present disclosure. The system 100 may comprise, for example, a plurality of UEs 110, which may use an access network 120 to access a core network 130.

UE 110 may be an end-user or client device or station, such as a mobile device, a wireless device, a laptop, a desktop, a tablet, etc. As illustrated in FIG. 1, UE 110 may support, one or more access technologies to communicate with GSM EDGE Radio Access Network (GERAN) 121, Universal Terrestrial Radio Access Network (UTRAN) 122, and/or Evolved-UTRAN (E-UTRAN)/LTE 123. UE 110 may transmit and receive control and data signals via one or more transceivers and provide various applications for a user, such as metering applications, etc.

Access network 120 may provide one or more radio access technologies, such as GERAN 121, UTRAN 122, E-UTRAN/LTE 123. Core network 130 may comprise one or more networks, such as Serving GPRS Support Node (SGSN) 131, Mobility Management Entity (MME) 132, Home Subscriber Server (HSS) 133, SERVING GATEWAY 134, Packet Data Network (PDN) GATEWAY 135, and operator's Internet Protocol services 136 such as IP Multimedia Subsystem (IMS), Packet Switched Streaming Service (PSS), etc. The system 100 may interconnect with other components (not shown for simplicity). For example, access network 120 may also include other access technologies such as Code Division Multiple Access (CDMA), Wideband CDMA (WCDMA), WLAN, Worldwide Interoperability for Microwave Access (WiMAX), etc., not shown in FIG. 1.

GERAN 121 may comprise a plurality of base transceiver stations and base station controllers. A base transceiver station provides an initial access point that a UE 110 may use to access wireless services. A base transceiver station may transmit and receive radio signals via one or more transceivers that allow it to serve several different frequencies and different sectors of a cell A base transceiver station may encrypt and decrypt communications. One base station controller may control or mange a plurality of base transceiver stations. A base station controller may allocate radio channels, receive measurement from a UE 110, and control handover between different base transceiver stations.

UTRAN 122 may comprise a plurality of Node Bs and Radio Network Controllers (RNCs). A Node B in UTRAN 122 is similar to a base transceiver station in GERAN 121. A Node B may include one or more radio frequency transceivers used to directly communicate with a plurality of UEs 110. A Node B may serve one or more cells depending on its configuration and antenna type. An RNC may be responsible for controlling a plurality of Node Bs that are connected to it. An RNC may also perform radio resource management and some mobility management functions, An RNC may further connect to a circuit switched core network through media gateway and to SGSN 131 in packet switched core network.

E-UTRAN/LTE 123 may comprise a plurality of evolved Node Bs (eNBs). An eNB may perform a radio resource management function. An eNB may also schedule and transmit paging messages and broadcast information, and measure and report measurement configurations for mobility and scheduling. An eNB may further select an MME 132 at UE 110 attachment and route user plane data toward SERVING GATEWAY 134.

GERAN 121 and UTRAN 122 may communicate with SGSN 131 for their data services. E-UTRAN/LTE 123 may communicate with MME 132 for its data services. SGSN 131 and MME 132 may also communicate with each other, when necessary.

SGSN 131 may be responsible for delivery of data packets to and from a UE 110 within its geographical service area. SGSN 131 may perform packet routing and transfer, mobility management, attach/detach and location management, logical link management, and authentication and charging functions.

MME 132 is a control node for E-UTRAN/LTE 123. MME 132 may be responsible for idle mode UE paging and tagging procedures, including retransmissions. MME 132 may also be responsible for choosing a SERVING GATEWAY 134 for a UE 110 at a time of initial attach and at a time of intra-LTE handover involving core network node relocation, MME 132 may further be responsible for authenticating a user by interacting with HSS 133.

HSS 133 may be a database storing user-related and subscription-related information. Exemplary functions of HSS 133 may include mobility management, call and session establishment support, user authentication and access authorization.

SERVING GATEWAY 134 may be responsible for routing and forwarding user data packets, while also acting as a mobility anchor for a user plane during inter-eNodeB handovers and as an anchor for mobility between LTE and other 3GPP technologies. For a UE 110 in an idle state, SERVING GATEWAY 134 may trigger paging when downlink data arrives for the UE 110 and terminate a downlink data path. Exemplary functions of SERVING GATEWAY 134 may include managing and storing UE contexts, e.g., parameters of the IP bearer service, network internal routing information, and replicating user traffic in case of lawful interception.

PDN GATEWAY 135 may provide connectivity between a UE 110 and an external packet data network and act as a point of exit and entry for data traffic to and from the UE 110. A UE 110 may have simultaneous connectivity with more than one PDN GATEWAY 135 so as to access multiple PDNs, PDN GATEWAY 135 may perform policy enforcement, packet filtering for each user, sharing support, lawful interception, and packet screening. PDN GATEWAY 135 may further provide data mobility between 3GPP and non-3GPP technologies such as WiMAX, CDMA1X, and (EVolution Data Optimized) EVDO.

An operator may provide its specific IP services to deliver certain applications. Operator's IP services 136 may include, for example, IMS and PSS. IMS Is an architectural framework for delivering IP multimedia services based on session-related protocols defined by Internet Engineering Task Force (IETF). IMS may facilitate access to multimedia and voice applications from wireless and wireline terminals. PSS may provide a streaming platform for different applications, such as news at very low bitrates using still images and speech, music at various bitrates and qualities, video clips, etc. In addition to streaming, the platform may also support progressive downloading of media for selective media types.

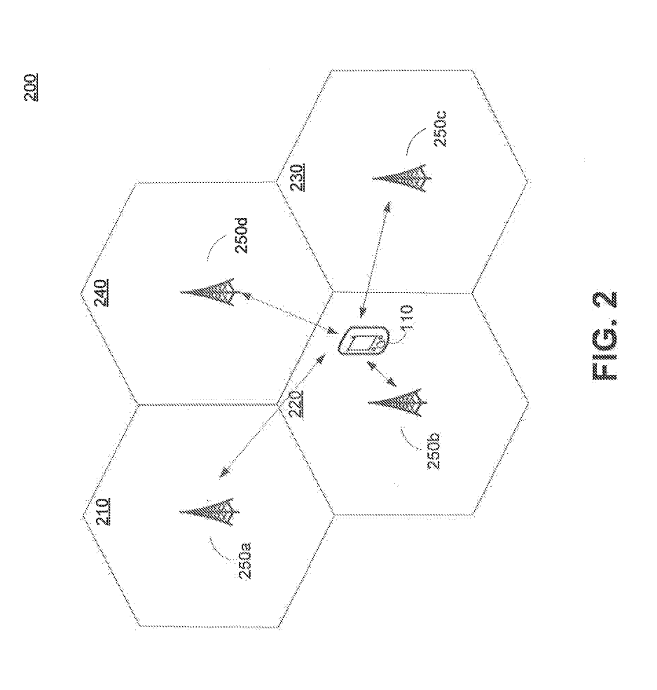

FIG. 2 illustrates an exemplary system for providing uplink and downlink services according to an embodiment of the present disclosure. In particular, FIG. 2 shows a plurality of cells 210-240 managed by a plurality of base stations 250a-250d in order to provide data services to UEs, such as UE 110, in wireless or cellular network. Base station 250 (250a-250d) provides an initial access point to transmit and receive radio signals to and from a UE 110. Base station 250 may be, for example, a base transceiver station in GERAN 121, a Node B in UTRAN 122, or eNB in E-UTRAN/LTE 123. Although a base station 250 may control a plurality of cells, the exemplary FIG. 2 shows one base station controlling one cell. Base stations 250a-250d and UE 110 may transmit and receive a plurality of uplink and down link control signals, find uplink and down link data signals. For example, a UE 110 may generate two different scrambling sequence based on two different initialization codes to maintain connection with a base station 250b in a cell 220 and a base station 250d in a cell 240. One scrambling sequence may be generated from an initialization code based on a cell ID of the base station 250b, an RNTI of UE 110, a codeword index for base station 250b, and a transmission slot index of base station 250b. Another scrambling sequence may be generated from an initialization code based on a cell ID of the base station 250d, an RNTI of UE 110, a codeword index for base station 250d, and a transmission slot index of base station 250d, If UE 110 moves into range of a base station 250c in a cell 230, UE 110 may generate a third scrambling sequence based on parameters associated with the base station 250c during transition.

In the current LTE system, the scrambling code generation depends on a UE common parameter, nₛ, which refers to the slot index within a radio frame. Since initialization of the scrambling code generation depends only on slot index and not on any radio frame depending index, the scrambling code repeats every radio frame. This may lead to potential loss of interference averaging when using repetition factors longer than a radio frame.

To avoid such interferences, disclosed embodiments may provide a different scrambling code for each repetition, based on, e.g., a common frame index such as a frame number N_{fr}, or a slot allocation index N_{alloc}, rather than a UE common parameter, nₛ.

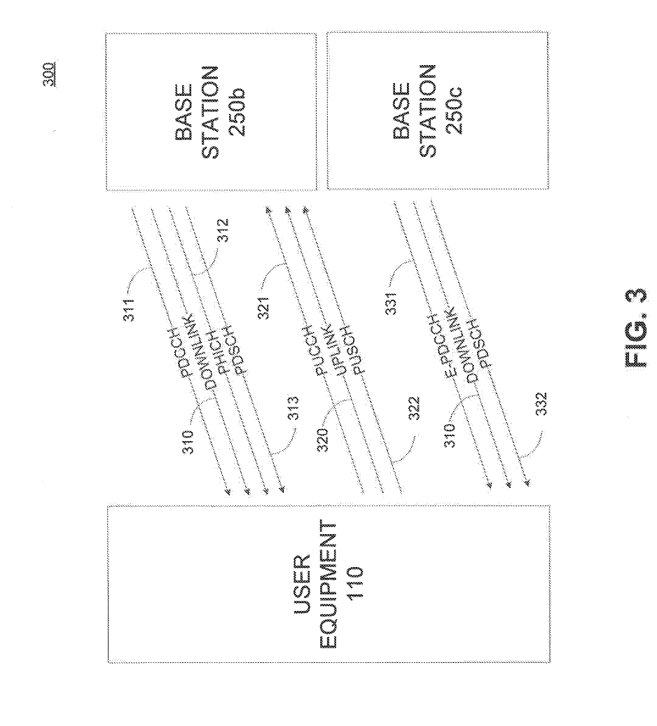

FIG. 3 illustrates an exemplary system providing uplink and downlink services and its control and data channel transmissions according to an embodiment of the present disclosure. Uplink and downlink services may include generating and transmitting uplink and downlink control/data signals between a UE and a base station, e.g., 250a-250d. An uplink and downlink physical channel corresponding to a set of resource elements carrying information originating from higher layers is exchanged between a UE 110 and a base station, e.g., 250a-250d.

An uplink physical channel may include, for example, one or more of a Physical Uplink Control CHannel (PUCCH), a Physical Uplink Shared CHannel (PUSCH), and a Physical Random Access CHannel (PRACH).

A downlink physical channel may include, for example, one or more of a PDSCH, Physical Broadcast CHannel (PBCH), a Physical Multicast CHannel (PMCH), a Physical Control Format Indicator CHannel (PCFICH), a Physical Downlink Control CHannel (PDCCH), a Physical Hybrid ARQ Indicator CHannel (PHICH), and an Enhanced-PDCCH (E-PDCCH).

For example, PDCCH or E-PDCCH may carry DCI to indicate resource assignment in uplink or downlink for one RNTI. A DCI may convey various pieces of information, including scheduling information, requests for aperiodic Channel Quality Indicator (CQI) reports, notifications of Multicast Control CHannel (MCCH) changes, and uplink power control commands, etc. There are various DCI formats. For example, DCI format 0 is used for scheduling of PUSCH in one uplink cell, DCI format 1 is used for scheduling of one PDSCH codeword in one cell. DCI format 1A is used for the compact scheduling of one PDSCH codeword in one cell and random access procedure initiated by a PDCCH order. DCI format 2A carries a carrier indicator, resource allocation header, resource block assignment, precoding information, and so on. DCI format 2B carries scrambling identity, downlink assignment index, carrier indicator, resource allocation header, resource block assignment, and so on.

FIG. 3 shows an exemplary system 300 in which a base station 250b may be configured to generate a scrambling code and initialize the scrambling code at a start of a radio frame or subframe transmission. The base station 250b may be configured to send PDCCH 311, PHICH 312, and PDSCH 313 data to the UE 110 via downlink 310. The UE 110 may be configured to generate a scrambling code and initialize the scrambling code at a start of a radio frame or subframe transmission. The UE 110 may also be configured to send PUCCH 321 and PUSCH 322 data to the base station 250b via uplink 320. Another base station 250c may be configured to send a UE 110 E-PDCCH 311 and PDSCH 332 via downlink 310. Base station 250c may be further configured to generate a scrambling code and initialize the scrambling code at a start of a radio frame or subframe transmission.

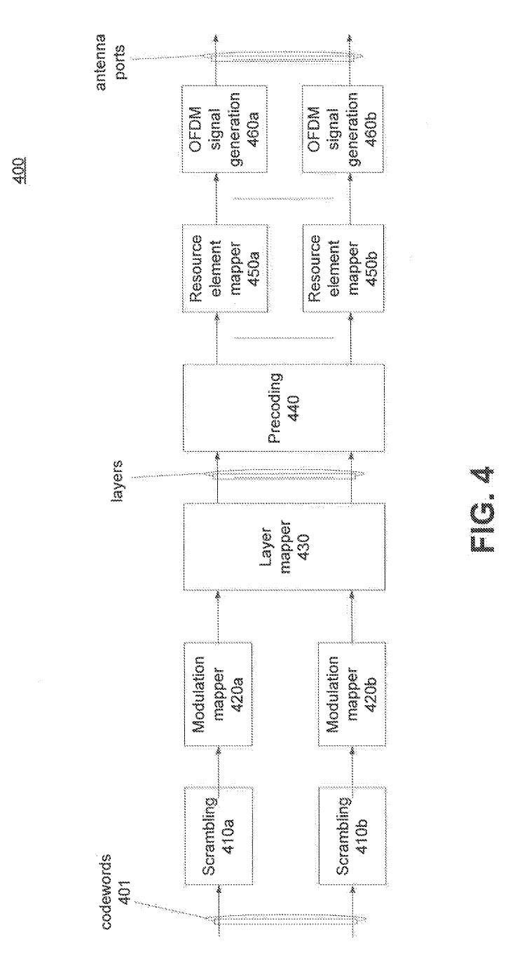

FIG. 4 illustrates an exemplary sequence generator process according to an embodiment of the present disclosure. In particular, FIG. 4 shows an exemplary downlink physical channel processing procedure. A baseband signal representing a downlink physical channel is defined in terms of the following steps: codewords 401 are scrambled in scrambling step 410a and 410b. Data bits from each channel are mapped to complex valued modulation symbols by a modulation mapper, at step 420a and 420b, and mapped to layers 402 in a layer mapper, at step 430. Each layer may be precoded in a precoder at precoding step 440, where it may be identified by a preceding vector of size equal to a number of transmit antenna ports. The output of the precoding step 440 is mapped to resource elements in resource element mapper 450a and 450b. A resource element is defined to be a smallest unit of resource in LTE and comprises one Orthogonal Frequency-Division Multiplexing (OFDM) subcarrier for duration of one OFDM symbol The resource elements are translated into a complex valued OFDM symbol by means of an Inverse Fast Fourier Transform (IFFT), in OFDM signal generation 460a and 460b, and output to antenna ports 403.

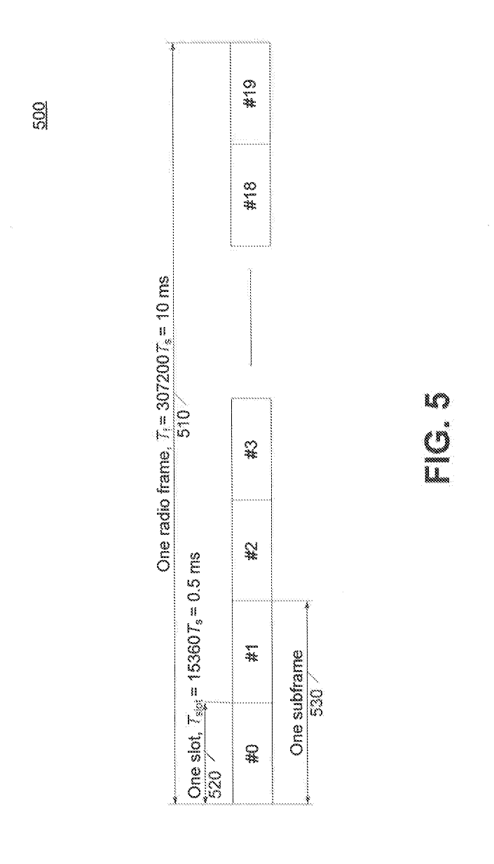

FIG. 5 illustrates an exemplary frame structure according to an embodiment of the present disclosure. In the exemplary frame structure 500, each radio frame 510 is T_{f}=307200·Tₛ=10 ms long and consists of 20 slots of length Tₛₗₒₜ=15360·Tₛ=0.5 ms 520, numbered from 0 to 19. A subframe 530 is defined as two consecutive slots, where subframe i consists of slots 2i and 2i+1.

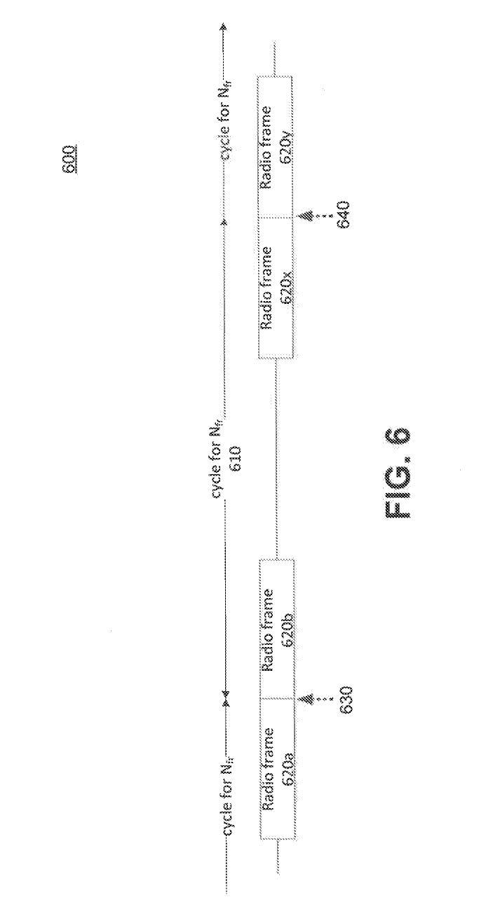

FIG. 6 illustrates an exemplary frame structure for initiating a scrambling code generator based on a common cycle according to an embodiment of the present disclosure, A cycle 610 of a plurality of radio frames based on a common frame index, such as a frame number N_{fr}, is indicated in FIG. 6. A start of a radio frame 620b is indicated at 630, A start of a radio frame 620y is indicated at 640. A plurality of radio frames may be grouped in a cycle 610, where frame number N_{fr} is the radio frame index inside the cycle. Using the method 700, an initial state of a scrambling code generation may be initialized at a start of a subframe, based on frame number N_{fr} in cycle 610 and slot index or subframe index in the radio frame.

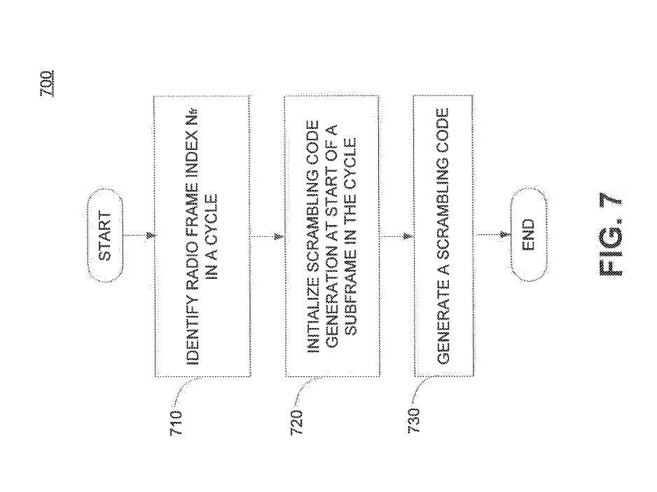

FIG. 7 illustrates an exemplary method for initiating a scrambling code generator based on a common cycle according to an embodiment of the present disclosure. Method 700 may be executed by one or more devices included in a system apparatus, a base station apparatus, or a UE apparatus, such as a scrambling sequence generator, or other processing device. Method 700 may include identifying a radio frame index N_{fr} in a cycle of a plurality of radio frames at step 710. Method 700 may also include initializing scrambling code generation at a start of a subframe in the identified cycle based on at least N_{fr} at step 720. Method 700 may further include generating a scrambling code at step 730.

The method 700 may be repeated in the beginning of the every subframe in every cycle in method 600. The start of the cycle may be tied to a start of a certain radio frame in a cell by counting from, e.g., system frame number (SFN). For example, N_{fr}=SFN % N_{fr,max}, where N_{fr,max} equals the maximum frame number in the cycle 610 and % equals modulus operation, The SFN is defined currently by the Master Information Block (MIB) information as described in 3GPPTS 36.331 and it is a common parameter for all UEs in a cell. Hence, all UEs in a cell would have the same starting position of the scrambling code cycle and every UE would have the same timing for the N_{fr}. In a special case N_{fr}=SFN.

An additional offset parameter X to the SFN may be signaled either UE specifically or non UE specifically using higher layer signaling. This would enable UE timing differentiation of the cycle 610. In this case N_{fr}=(SFN+X) % N_{fr,max} where X is user specific signaled offset value using higher layer signaling.

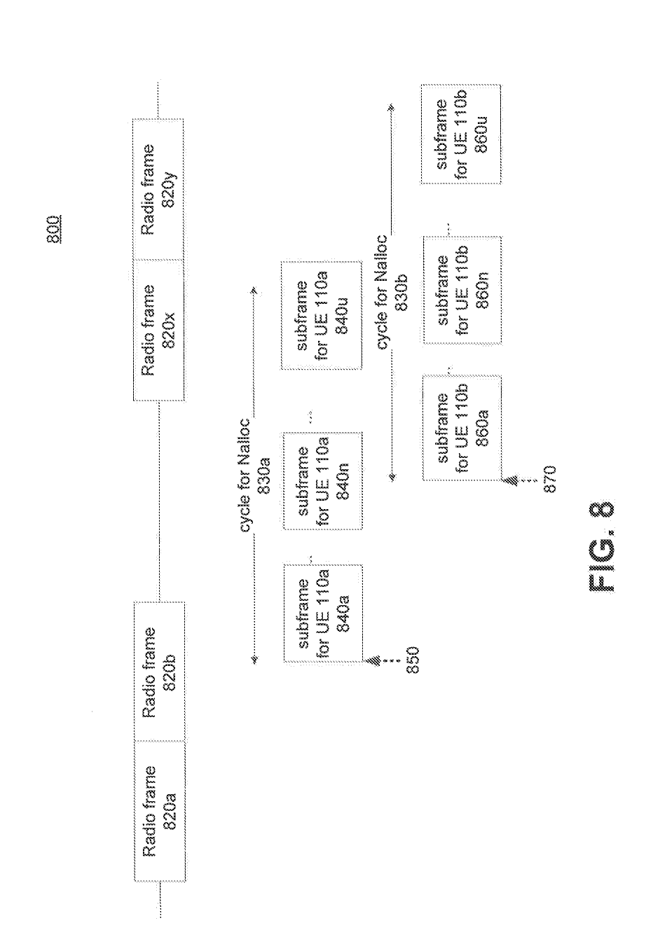

FIG. 8 illustrates a subframe structure for initiating a scrambling code generator based on scrambling code pattern timing according to an embodiment of the present disclosure, The subframe structure 800 shows a cycle of a plurality of subframes to be transmitted to a UE 110a (e.g., subframes for UE 110a 840a, ,.840n, . . . , and 840u) and another cycle of a plurality of subframes to be transmitted to a UE 110b (e.g., subframes for UE 110b 860a, . . . , 860n, . . . , and 860u) based on a slot allocation index N_{alloc} for repetitions. A cycle of a plurality of subframes to be transmitted to a UE based on a slot allocation index N_{alloc} for repetitions is noted in 830a or 830b in FIG. 8. The N_{alloc} equals zero for the first transmitted subframe indicated by the scheduling of the PDCCH. The N_{alloc} is incremented for each successive repetition and the N_{alloc} is used when setting the initial state of the scrambling code generator in each subframe. The resulting scrambling code timing is UE-specific, since the beginning of the sequence depends on a scheduling of data to be transmitted to a specific UE, rather than on a radio frame timing. This approach is particularly applicable to PDSCH data and DM-RS. A start of a subframe to be transmitted to a specific UE in an identified cycle is noted at 850 and 870 in FIG. 8.

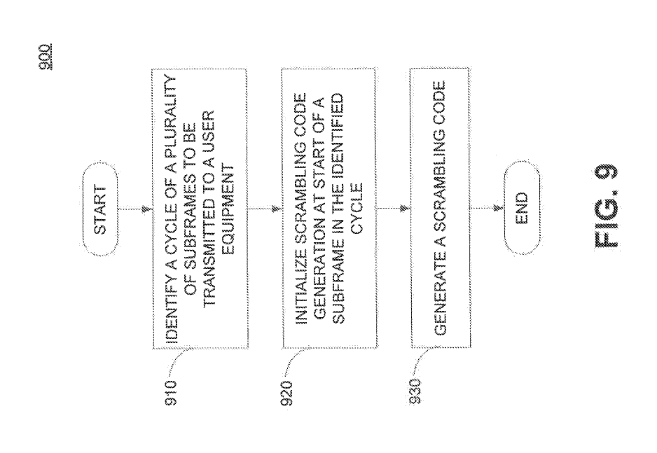

FIG. 9 illustrates another exemplary method for initiating a scrambling code generator based on scrambling code pattern timing according to an embodiment of the present disclosure. Method 900 may be executed by one or more devices included in a system apparatus, a base station apparatus, or a UE apparatus, such as a scrambling sequence generator, or other processing device. Method 900 may include identifying a cycle of a plurality of subframes to be transmitted to a UE (e.g., subframes 840a, . . . , 840n, . . . , and 840u in FIG. 8) at step 910. A cycle of a plurality of subframes to be transmitted to a UE based on a slot allocation index N_{alloc} for repetitions is indicated at 830a or 830b. Method 900 may also include initializing scrambling code generation at start of a subframe in the identified cycle based on at least the slot allocation index N_{alloc} at step 920. A start of the first subframe to be transmitted to a UE in an identified cycle is indicated at 850 or 870. Method 900 may further include generating a scrambling code at step 930.

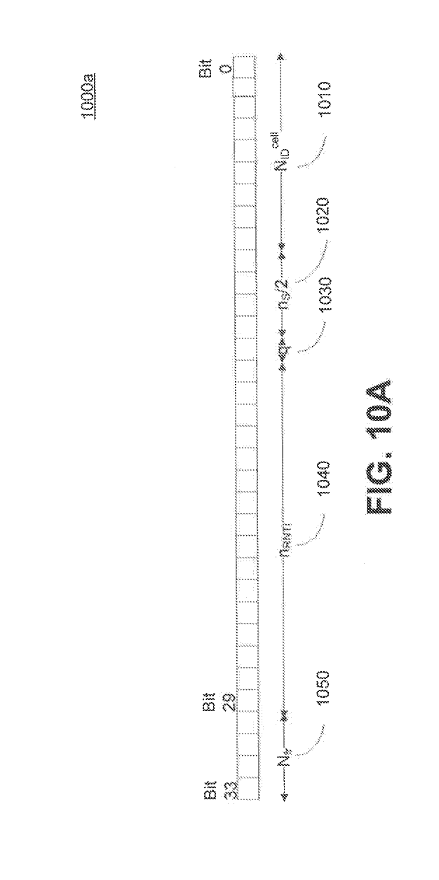

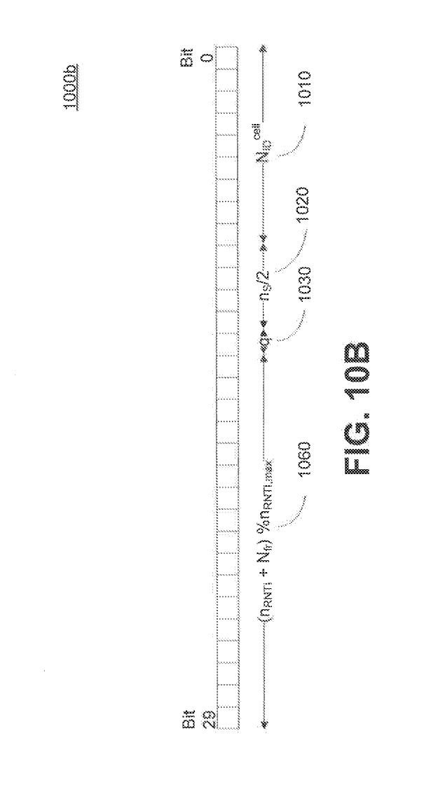

The initialization of the scrambling code generator is performed by setting the initial state using a bit pattern as described in section 7.2 of the 3GPPTS 36.211. FIGS. 10A and 10B show exemplary applications of the alternative new methods on setting initial state of the scrambling code generator described in FIGS. 7 and 9 for PDSCH scrambling. These alternative initial state setting methods for scrambling channels may also be applied to other channels as well, e.g., at least PDCCH, E-PDCCH, PHICH, PBCH, PUCCH and PUSCH. It is also possible to apply these alternative methods of initializing scrambling in other channels and other systems.

FIG. 10A examples an initial state scrambling structure consisting of N_{ID}^{cell} 1010 (9 bits), nₛ/2 1020 (4 bits), q1030 (1 bit), n_{RNTI} 1040 (16 bits), and N_{fr} 1050 (4 bits). According to section 7.2 in 3GPPTS 36.211, an initial state of a scrambling code generator is 31 bits long. Further, current initialization reserves 4 bits for nₛ 1020. The nₛ cannot be directly used to provide longer slot indexing due to the limited space. As depicted in FIG. 10A, N_{fr} 1050 may be appended into an initial state variable assuming that size of N_{fr} equals 4 bits in order to support 160 subframe sequence length assuming subframe index would be 10N_{fr}+└nₛ/2┘, in other words:

cᵢₙᵢₜ=N_{fr}2³⁰+n_{RNTI}2¹⁴+q2¹³+└nₛ/2┘2⁹+N_{ID}^{cell} (Equation 6).

In this case, appending N_{fr} into an initial state variable would require that the polynomial in the scrambling code generation would need to be longer than current 31 bits.

In another embodiment, FIG. 10B examples another initial state scrambling structure consisting of N_{ID}^{cell} 1010 (9 bits), nₛ/2 1020 (4 bits), q 1030 (1 bit), and (n_{RNTI}+N_{fr}) % n_{RNTI,max} 1060 (16 bits). In this embodiment, the n_{RNTI} is transformed using the N_{fr}, while maintaining 31 bit polynomial. In other words, the n_{RNTI} field is modified according to (n_{RNTI}+N_{fr}) % n_{RNTI,max} 1050, where % signifies the modulus over the maximum value of the 16-bit unsigned integer n_{RNTi,max} in FIG. 10B. This is described by the following equation:

cᵢₙᵢₜ=((n_{RNTI}+N_{fr}) % n_{RNTI,max})2¹⁴+q2¹³+└nₛ/2┘2⁹+N_{ID}^{cell} (Equation 7).

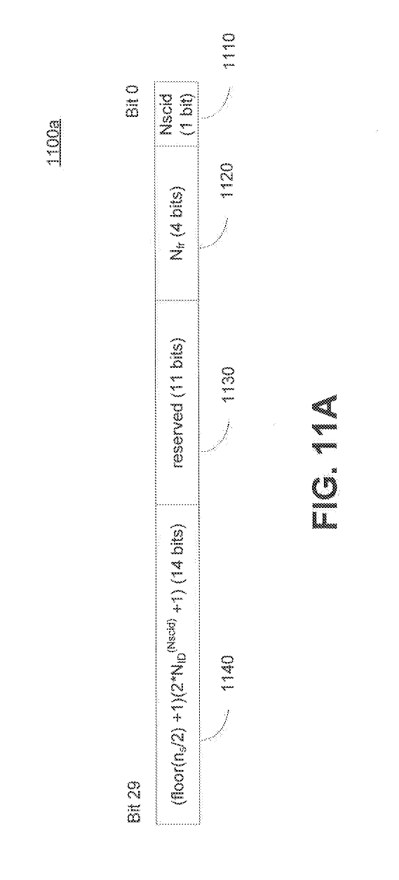

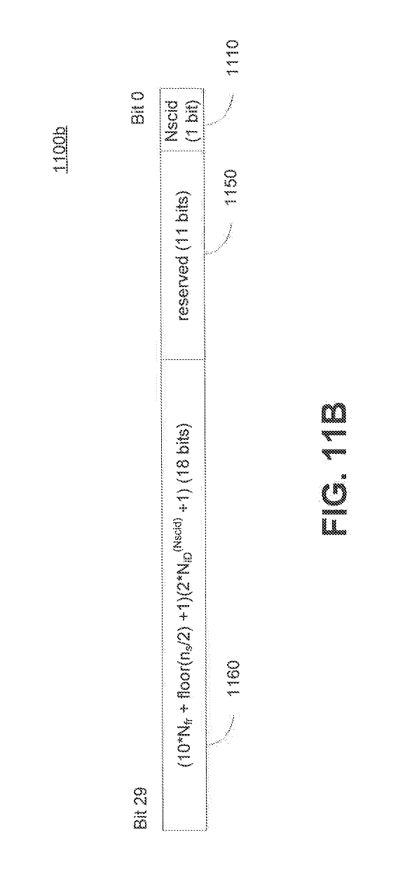

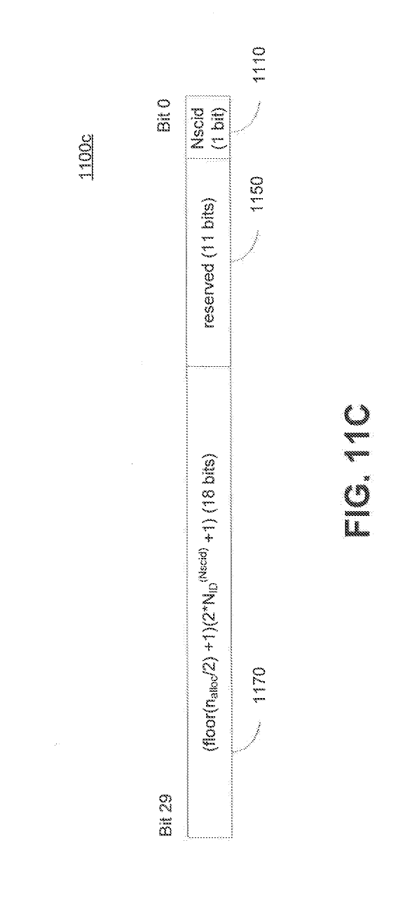

The following FIGS. 11A-11C show exemplary applications of the methods described in FIGS. 6 and 8 to DM-RS. It will be recognized that these alternative methods can be applied to other channels as well, e.g., at least PDCCH, E-PDCCH, PHICH, PBCH, PUCCH and PUSCH. It is also possible to apply these alternative methods of initializing scrambling in other channels and other systems.

FIG. 11A illustrates a first exemplary initial state setting according to an embodiment of the present disclosure, The first exemplary initial state setting is to add N_{fr} 1120 in unused bit locations. It leads to an initial state of a scrambling code generator as follows:

cᵢₙᵢₜ=(└hₛ/2┘+1)(2n_{ID}⁽ⁿ^{_{SCID}}⁾+1)2¹⁶+(N_{fr})2¹+n_{SCID} (Equation 8).

FIG. 11B illustrates a second exemplary initial state setting according to an embodiment of the present disclosure. The second exemplary initial state setting is to add N_{fr} directly into a first part of the equation 1160 reducing an amount of unused bits 1150. It leads to an initial state of a scrambling code generator as follows:

cᵢₙᵢₜ=(10N_{fr}+└nₛ/2┘⇄1)(2n_{ID}⁽ⁿ^{_{SCID}}⁾+1)2¹²+n_{SCID} (Equation 9).

FIG. 11C illustrates a third exemplary initial state setting according to an embodiment of the present disclosure. The third exemplary initial state setting is to use an UE allocation dependent initialization, 1170 where slot allocation index N_{alloc} is used. It leads to an initial state of a scrambling code generator as follows:

cᵢₙᵢₜ(└N_{alloc}/2┘+1)(2n_{ID}⁽ⁿ^{_{SCID}}⁾+1)2¹²+n_{SCID} (Equation 10).

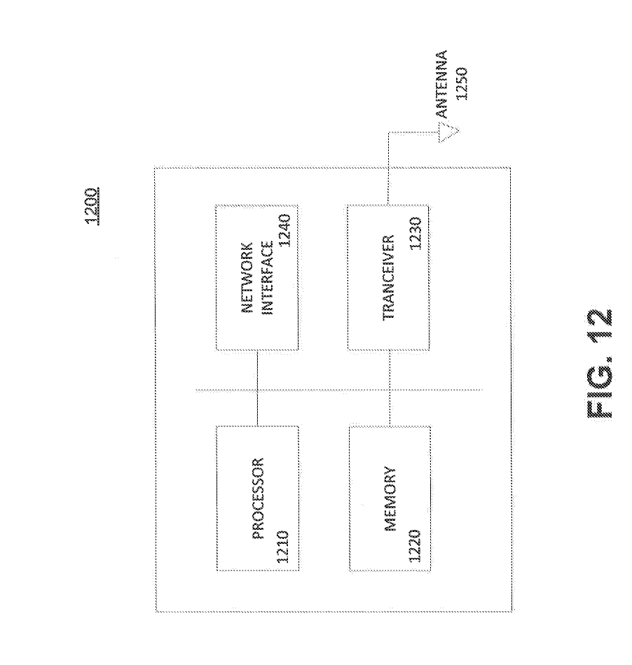

FIG. 12 illustrates an exemplary block diagram of a system apparatus or a UE apparatus. A system apparatus or a UE apparatus 1200 may include one or more processors 1210, one or more memories 1220, one or more transceivers 1230, and one or more network interfaces 1240.

The one or more processors 1210 may comprise a CPU (central processing unit) and may include a single core or multiple core processor system with parallel processing capability. The one or more processors 1210 may use logical processors to simultaneously execute and control multiple processes. One of ordinary skill in the art would understand that other types of processor arrangements may be implemented to provide for the capabilities disclosed herein,

The one or more processors 1210 execute some or all of the functionalities described above for either a UE 110 apparatus or system (e.g., base station 250) apparatus. Alternative embodiments of the system apparatus may include additional components responsible for providing additional functionality, including any of the functionality identified above and/or any functionality necessary to support the embodiments described above.

The one or more memory 1220 may Include one or more storage devices configured to store information used by the one or more processor 1210 to perform certain functions according to exemplary embodiments. The one or more memory 1220 may include, for example, a hard drive, a flash drive, an optical drive, a random-access memory (RAM), a read-only memory (ROM), or any other computer-readable medium known in the art. The one or more memory 1220 can store instructions to be executed by the one or more processor 1210. The one or more memory 1220 may be volatile or non-volatile, magnetic, semiconductor, optical, removable, non-removable, or other type of storage device or tangible computer-readable medium.

The one or more transceiver 1230 may be used to transmit signals to one or more radio channels, and receive signals transmitted through the one or more radio channels via one or more antennas 1250.

The one or more network interface 1240 may comprise wired links, such as an Ethernet cable or the like, and/or wireless links to one or more entities such as access nodes, different networks, or UEs. The one or more network interface 1240 allow the one or more processor 1210 to communicate with remote units via the networks.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive, Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method of providing efficient scrambling code generation in a wireless network, the method comprising:
identifying a cycle of a plurality of radio frames based on a common frame index;
initializing scrambling code generation at start of a subframe based on at least radio frame index in the cycle of the plurality of radio frames; and
generating a scrambling code.

2. The method of claim 1, wherein initiating the scrambling code generation at start of a subframe comprises deriving common frame index from a system frame number.

3. The method of claim 1, wherein the cycle of the plurality of radio frames is equal or longer than a predetermined maximum number of repetitions.

4. The method of claim 1, wherein the scrambling code generation is initialized at start of a subframe in the identified cycle of the plurality of radio frames for at least one of Physical Downlink Shared CHannel (PDSCH), Demodulation Reference Signal (OM-RS), Physical Downlink Control CHannel (PDCCH), Enhanced-PDCCH (E-PDCCH), Physical Hybrid ARQ Indicator CHannel (PHICH), Physical Broadcast CHannel (PBCH), Physical Uplink Control CHannel (PUCCH), and Physical Uplink Shared CHannel (PUSCH).

5. The method of claim 1, wherein a common frame index comprises a frame number N_{fr}

6. The method of claim 5, further comprising appending a frame number N_{fr} into an initial state variable.

7. The method of claim 6, wherein appending a frame number N_{fr} into an initial state variable leads to an initialization equation:
cᵢₙᵢₜ=N_{fr}2³⁰+n_{RNTI}2¹⁴+q2¹³+└nₛ/2┘2⁹+N_{ID}^{cell},
wherein cᵢₙᵢₜ is an initial state of the scrambling code generator, n_{RNTI}, is an radio network temporary identifier, q is a codeword index, nₛ is a slot number within a radio frame, and N_{ID}^{cell} is a physical layer cell identity.

8. The method of claim 8, wherein the initialization equation applies to initialization of an initial state for PDSCH scrambling.

9. The method of claim 5, wherein initializing the scrambling code at start of a subframe in the identified cycle of the plurality of radio frames based on a frame number N_{fr} is based on an initialization equation:
cᵢₙᵢₜ=((n_{RNTI}+N_{fr}) % n_{RNTI,max})2¹⁴+q2¹³+└nₛ/2┘2⁹+N_{ID}^{cell},
wherein, cᵢₙᵢₜ is an initial state of the scrambling code generator, n_{RNTI}, is an radio network temporary identifier, n_{RNTI,max} is a maximum value of a Radio Network Temporary Identifier, q is a codeword index, nₛ is a slot number within a radio frame, N_{ID}^{cell} is a physical layer cell identity, and % is modulus over the maximum value of 16 bit unsigned integer n_{RNTI,max}.

10. The method of claim 10, wherein an initial state based on the initialization equation has 31-bits length.

11. The method of claim 10, wherein the initialization equation applies to initialization of an initial state for PDSCH scrambling.

12. The method of claim 5. wherein initializing the scrambling code at start of a subframe in the identified cycle of the plurality of radio frames based on a frame number N_{fr} is based on an initialization equation:
cᵢₙᵢₜ=(└nₛ/2┘+1)(2n_{ID}ⁿ^{_{SCID}}⁾+1)2¹⁶+(N_{fr})2¹+n_{SCID},
wherein cᵢₙᵢₜ is an initial state of the scrambling code generator, nₛ is a slot number within a radio frame, n_{ID}ⁿ^{_{SCID}}⁾ is an identifier of a scrambling identity field, and n_{SCID} is a scrambling identity field.

13. The method of claim 13, wherein the initialization equation applies to initialization of an initial state for DM-RS scrambling.

14. The method of claim 5, wherein initializing the scrambling code at start of a subframe in the identified cycle of the plurality of radio frames based on a frame number N_{fr} is based on an initialization equation:
cᵢₙᵢₜ=(10N_{fr}+└nₛ/2┘+1)(2n_{ID}⁽ⁿ^{_{SCID}}⁾+1)2¹²+n_{SCID},
wherein cᵢₙᵢₜ is an initial state of the scrambling code generator, nₛ is a slot number within a radio frame, n_{ID}⁽ⁿ^{_{SCID}}⁾ is an identifier used in initialization of scrambling, and n_{SCID} is indicated by a scrambling identity field.

15. The method of claim 15, wherein the initialization equation applies to initialization of an initial state for DM-RS scrambling.

16. A method of providing efficient scrambling code generation in a wireless network, the method comprising:
identifying a cycle of a plurality of subframes based on a slot allocation index;
initializing scrambling code generation at start of a subframe in the identified cycle of the plurality of subframes based on the slot allocation index; and.
generating a scrambling code.

17. The method of claim 17, wherein the scrambling code generation is initialized at start of a subframe in the identified cycle of the plurality of subframes for at least one of Physical Downlink Shared CHannel (PDSCH) and Demodulation Reference Signal (DM-RS).

18. The method of claim 17, wherein initializing the scrambling code generation at start of a subframe in the identified cycle of the plurality of subframes based on the slot allocation index is based on an initialization equation:
cᵢₙᵢₜ=(└N_{alloc}/2┘+1)(2n_{ID}ⁿ^{_{SCID}}⁾+1)2¹²+n_{SCID},
wherein cᵢₙᵢₜ is an initial state of the scrambling code generator, N_{alloc} is a slot allocation index, n_{ID}⁽ⁿ^{_{SCID}}⁾ is an identifier of a scrambling identity field, and n_{SCID} is a scrambling identity field.

19. The method of claim 18, wherein an initial state based on the initialization equation has 31-bits length.

20. The method of claim 18, wherein the initialization equation applies to initialization of an initial state for DM-RS scrambling.

21. An apparatus of providing efficient scrambling code generation in a wireless network, the apparatus comprising;
a computer readable storage medium storing programming for execution by a processor; and
at least one processor, wherein the processor is configured to:
identify a cycle of a plurality of radio frames based on a common frame index;
initialize the scrambling code generation at start of a subframe based on at least radio frame index in the identified cycle of the plurality of radio frames; and
generate a scrambling code.

22. The apparatus of claim 21, wherein initiating the scrambling code generation at start of the subframe comprises deriving common frame index from system frame number.

23. The apparatus of claim 21, wherein the cycle of the plurality of radio frames is equal or longer than a predetermined maximum number of repetitions.

24. The apparatus of claim 21, wherein the scrambling code is initialized at start of a subframe in the identified cycle of the plurality of radio frames for at least one of Physical Downlink Shared CHannel (PDSCH), Demodulation Reference Signal (DM-RS), Physical Downlink Control CHannel (PDCCH), Enhanced-PDCCH (E-PDCCH), Physical Hybrid ARQ Indicator CHannel (PHICH), Physical Broadcast CHannel (PBCH), Physical Uplink Control CHannel (PUCCH), and Physical Uplink Shared CHannel (PUSCH).

25. The apparatus of claim 21, wherein a common frame index comprises a frame number N_{fr}

26. The apparatus of claim 25, the processor further is configured to append a frame number N_{fr} into an initial state variable.

27. The apparatus of claim 26, wherein appending a frame number N_{fr} into an initial state variable leads to an initialization equation:
cᵢₙᵢₜ=N_{fr}2³⁰+n_{RNTI}2¹⁴+q2¹³+└nₛ/2┘2⁹+N_{ID}^{cell},
wherein cᵢₙᵢₜ is an initial state of the scrambling code generator, n_{RNTI}, is an radio network temporary identifier, q is a codeword index, ns is a slot number within a radio frame, and N_{ID}^{cell} is a physical layer cell identity.

28. The apparatus of claim 27, wherein the initialization equation applies to initialization of an initial state for PDSCH scrambling.

29. The apparatus of claim 25, wherein initializing the scrambling code at start of a subframe in the identified cycle of the plurality of radio frames based on a frame number N_{fr} is based on an initialization equation:
cᵢₙᵢₜ=((n_{RNTI}+N_{fr}) % n_{RNTI,max})2¹⁴+q2¹³+└nₛ/2┘2⁹+N_{ID}^{cell},
wherein, cᵢₙᵢₜ is an initial state of the scrambling code generator, n_{RNTI}, is an radio network temporary identifier, n_{RNTI,max} is a maximum value of a Radio Network Temporary Identifier, q is a codeword index, nₛ is a slot number within a radio frame, N_{ID}^{cell} is a physical layer cell identity, and % is modulus over the maximum value of 16 bit unsigned integer n_{RNTI,max}.

30. The apparatus of claim 29, wherein an initial state based on the initialization equation has 31-bits length.

31. The apparatus of claim 29, wherein the initialization equation applies to initialization of an initial state for PDSCH scrambling.

32. The apparatus of claim 25, wherein initializing the scrambling code at start of a subframe in the identified cycle of the plurality of radio frames based on a frame number N_{fr} is based on an initialization equation:
cᵢₙᵢₜ=(└nₛ/2┘+1)(2n_{ID}ⁿ^{_{SCID}}⁾+1)2¹⁶+(N_{fr})2¹+n_{SCID},
wherein cᵢₙᵢₜ is an initial state of the scrambling code generator, nₛ is a slot number within a radio frame, n_{ID}⁽ⁿ^{_{SCID}}⁾ is an identifier of a scrambling identity field, and n_{SCID} is a scrambling identity field.

33. The apparatus of claim 32, wherein the initialization equation applies to initialization of an initial state for DM-RS scrambling.

34. The apparatus of claim 25, wherein initializing the scrambling code at start of a subframe in the identified cycle of the plurality of radio frames based on a frame number N_{fr} is based on an initialization equation:
cᵢₙᵢₜ=(10N_{fr}+└nₛ/2┘+1)(2n_{ID}⁽ⁿ^{_{SCID}}⁾+1)2¹²+n_{SCID},
wherein cᵢₙᵢₜ is an initial state of the scrambling code generator, nₛ is a slot number within a radio frame, n_{ID}^{(N}^{_{SCID}}⁾ is an identifier of a scrambling identity field, and n_{SCID} is a scrambling identity field.

35. The apparatus of claim 34, wherein the initialization equation applies to initialization of an initial state for DM-RS scrambling.

36. The apparatus of claim 21, wherein the apparatus is either a system apparatus or a user equipment apparatus.

37. An apparatus for providing efficient scrambling code generation in a wireless network, the apparatus comprising:
a computer readable storage medium storing programming for execution by a processor; and
at least one processor, wherein the processor is configured to:
identify a cycle of a plurality of subframes based on a slot allocation index; and
initialize the scrambling code generation at start of a subframe in the identified cycle of the plurality of subframes based on the slot allocation index; and.
generate a scrambling code;

38. The apparatus of claim 37, wherein the scrambling code is initialized at start of a subframe in the identified cycle of the plurality of subframes for at least, one of Physical Downlink Shared CHannel (PDSCH) and Demodulation Reference Signal (DM-RS).

39. The apparatus of claim 37, wherein identifying a cycle of a plurality of subframes based on a slot allocation index comprises identifying a cycle of a plurality of subframes to be transmitted to one user equipment based on a slot allocation index.

40. The apparatus of claim 37, wherein initializing the scrambling code at start of a subframe in the identified cycle of the plurality of subframes based on the slot allocation index is based on an initialization equation:
cᵢₙᵢₜ=(└N_{alloc}/2┘+1)(2n_{ID}ⁿ^{_{SCID}}⁾+1)2¹²+n_{SCID},
wherein cᵢₙᵢₜ is an initial state of the scrambling code generator, N_{alloc} is a slot allocation index, n_{ID}⁽ⁿ^{_{SCID}}⁾ is an identifier of a scrambling identity field, and n_{SCID} is a scrambling identity field.

41. The apparatus of claim 40, wherein an initial state based on the initialization equation has 31-bits length.

42. The apparatus of claim 40, wherein the initialization equation applies to initialization of an initial state for DM-RS scrambling.

43. The apparatus of claim 37, wherein the apparatus is either a system apparatus or a user equipment apparatus.
